(19) United States
(12) Patent Application Publication
(10) Pub. No.: US 2026/0014480 A1
(43) Pub. Date: Jan. 15, 2026

(54) METHOD AND APPARATUS FOR CONTROLLING VIRTUAL OBJECT, DEVICE, MEDIUM, AND PRODUCT

(71) Applicant: TENCENT TECHNOLOGY (SHENZHEN) COMPANY LIMITED, Shenzhen (CN)

(72) Inventor: Ziqi WEI, Shenzhen (CN)

(73) Assignee: TENCENT TECHNOLOGY (SHENZHEN) COMPANY LIMITED, Shenzhen (CN)

(21) Appl. No.: 19/333,560

(22) Filed: Sep. 19, 2025

Related U.S. Application Data
(63) Continuation of application No. PCT/CN2024/123381, filed on Oct. 8, 2024.

(30) Foreign Application Priority Data
Dec. 28, 2023 (CN) 202311837340.5

(51) Int. Cl. A63F 13/69; A63F 13/537; A63F 13/56; A63F 13/822

(52) U.S. Cl. CPC A63F 13/69; A63F 13/537; A63F 13/56; A63F 13/822

(57) ABSTRACT

A method for controlling a virtual object, performed by a computer device, includes displaying a virtual scene including a first virtual object and a first virtual piece, wherein the first virtual object corresponds to one or more virtual pieces including the first virtual piece; placing a virtual prop in the virtual scene when the first virtual piece is in a battle stage; controlling, based on a movement operation for the first virtual object, the first virtual object to move in the virtual scene; and triggering, based on the first virtual object moving to a position corresponding to the virtual prop, a prop effect of the virtual prop.

### CROSS-REFERENCE TO RELATED APPLICATIONS

This application is a continuation application of International Application No. PCT/CN2024/123381 filed on Oct. 8, 2024, which claims priority to Chinese Patent Application No. 202311837340.5 filed with the China National Intellectual Property Administration on Dec. 28, 2023, the disclosures of each being incorporated by reference herein in their entireties.

### FIELD

The present disclosure relates to computer technologies, and in particular, to a method and apparatus for controlling a virtual object, as well as to a device, a medium, and a product.

### BACKGROUND

An auto chess game is a turn-based board game. A player may purchase a virtual piece or select a virtual piece to participate in a battle (referred to as a “piece”) from owned virtual pieces, and then the pieces automatically battle against an enemy virtual piece lineup.

A virtual object, which can be operated and moved by the player, represents the player's character in the game. In a selection stage, the player may move the virtual object to obtain a piece. After a battle, the player may move the virtual object to obtain a trophy or other rewards.

In the foregoing solution, the user controls the virtual object in a limited manner, which adversely affects the interaction between the user and the virtual scene.

### SUMMARY

Some embodiments provide a method and an apparatus for controlling a virtual object, a device, a medium, and a product.

According to an aspect of the disclosure, a method for controlling a virtual object, performed by a computer device, includes displaying a virtual scene including a first virtual object and a first virtual piece, wherein the first virtual object corresponds to one or more virtual pieces including the first virtual piece; placing a virtual prop in the virtual scene when the first virtual piece is in a battle stage; controlling, based on a movement operation for the first virtual object, the first virtual object to move in the virtual scene; and triggering, based on the first virtual object moving to a position corresponding to the virtual prop, a prop effect of the virtual prop.

According to an aspect of the disclosure, an apparatus for controlling a virtual object includes at least one memory configured to store computer program code; and at least one processor configured to read the program code and operate as instructed by the program code, the program code including first display code configured to cause at least one of the at least one processor to display a virtual scene including a first virtual object and a first virtual piece, wherein the first virtual object corresponds to one or more virtual pieces including the first virtual piece; second display code configured to cause at least one of the at least one processor to place a virtual prop in the virtual scene when the first virtual piece is in a battle stage; control code configured to cause at least one of the at least one processor to control, based on a movement operation for the first virtual object, the first virtual object to move in the virtual scene; and prop code configured to cause at least one of the at least one processor to trigger, based on the first virtual object moving to a position corresponding to the virtual prop, a prop effect of the virtual prop.

According to an aspect of the disclosure, a non-transitory computer-readable storage medium, storing computer code which, when executed by at least one processor, causes the at least one processor to display a virtual scene including a first virtual object and a first virtual piece, wherein the first virtual object corresponds to one or more virtual pieces including the first virtual piece; place a virtual prop in the virtual scene when the first virtual piece is in a battle stage; control, based on a movement operation for the first virtual object, the first virtual object to move in the virtual scene; and trigger, based on the first virtual object moving to a position corresponding to the virtual prop, a prop effect of the virtual prop.

The virtual prop may increase uncertainty in the outcome of the battle, which helps the player adjust a game strategy for the virtual pieces during the battle, thereby improving the interactivity of the auto chess game.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a structural block diagram of a computer system according to some embodiments.

FIG. 2 is a flowchart of a method for controlling a virtual object according to some embodiments.

FIG. 3 is a schematic diagram of a battle turn according to some embodiments.

FIG. 4 is a flowchart of a method for controlling a virtual object according to some embodiments.

FIG. 5 is a schematic diagram of a virtual board according to some embodiments.

FIG. 6 is a flowchart of a method for controlling a virtual object according to some embodiments.

FIG. 7 is a flowchart of a method for controlling a virtual object according to some embodiments.

FIG. 8 is a schematic diagram of a virtual scene of a preparation stage according to some embodiments.

FIG. 9 is a schematic diagram of an interface of a battle stage according to some embodiments.

FIG. 10 is a schematic diagram of an interface of a non-player character (NPC) placing a reward according to some embodiments.

FIG. 11 is a schematic diagram of an interface of a virtual object picking up a reward according to some embodiments.

FIG. 12 is a schematic diagram of an interface of a virtual object obtaining a reward according to some embodiments.

FIG. 13 is a schematic diagram of an interface of a virtual object obtaining a reward according to some embodiments.

FIG. 14 is a schematic diagram of an interface of placing a virtual trap according to some embodiments.

FIG. 15 is a schematic diagram of an interface of a virtual object triggering a trap according to some embodiments.

FIG. 16 is a flowchart of a related turn according to some embodiments.

FIG. 17 is a structural block diagram of an apparatus for controlling a virtual object according to some embodiments.

FIG. 18 is a structural block diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Terms used in some embodiments are for the purpose of describing embodiments only and are not intended to limit the disclosure. Singular forms of “a”, “said”, and “the” used in some embodiments and the appended claims are also intended to include plural forms, unless the context clearly indicates otherwise. The term “and/or” used herein indicates and includes any or all possible combinations of one or more associated listed items.

Although terms such as “first” and “second” may be used in some embodiments to describe various information, the information is not limited by these terms. These terms are used to distinguish between information of the same type. For example, without departing from the scope of the disclosure, a first parameter may also be referred to as a second parameter, and the second parameter may be referred to as a first parameter. Depending on the context, for example, the word “if” used herein may be interpreted as “in a case where,” “when,” or “in response to a determination.”

The terms “module[s]” or “unit[s]” may refer to hardware logic, a processor or processors executing computer software code, or a combination of both. The “modules” or “units” may also be implemented in software stored in a memory of a computer or a non-transitory computer-readable medium, where the instructions of each unit are executable by a processor to thereby cause the processor to perform the respective operations of the corresponding module or unit.

Each module or unit may exist respectively or be combined into one or more units. Some modules or units may be further split into multiple smaller function subunits, thereby implementing the same operations without affecting the technical effects of some embodiments. The modules or units are divided based on logical functions. In actual applications, a function of one module or unit may be realized by multiple modules or units, or functions of multiple modules or units may be realized by one module or unit. In some embodiments, the apparatus may further include other modules or units. In actual applications, these functions may also be realized cooperatively by the other modules or units, and may be realized cooperatively by multiple modules or units.

Object information (including but not limited to object device information, object personal information, and the like) and data (including but not limited to data configured for analysis, stored data, exhibited data, and the like) involved in some embodiments are all information and data authorized by objects or fully authorized by all parties, and collection, use, and processing of relevant data should comply with relevant laws, regulations, and standards of relevant countries and regions.

Terms involved in some embodiments are briefly introduced.

Auto chess game: It is a term for a turn-based board-and-card game of an electronic strategy type. A basic game rule is that a player selects a combination of different types of pieces, arranges the combination on the player's board, and then the system automatically battles them against the pieces of another player. A particular number of hit points is deducted from the defeated side in each round, and this process is repeated multiple times until only one player among a plurality of players remains.

Board: It refers to an area configured to prepare and perform a battle in a battle interface of an auto chess game. The board may be any one of a two-dimensional (2D) virtual board, a 2.5-dimensional (2.5D) virtual board, or a three-dimensional (3D) virtual board. The board is divided into a battle area and a preparation area. The battle area includes several battle squares of the same size, configured for placing battle pieces that participate in a battle process. The preparation area includes several preparation squares configured for placing preparation pieces; these preparation pieces do not participate in the battle process but may be dragged and placed in the battle area during a preparation stage. The player may sell, equip, and reserve a piece in the preparation area, and the preparation area has an upper limit for piece capacity.

Regarding an arrangement manner of squares in the battle area, in some embodiments, the battle area includes n (rows)×m (columns) battle squares. n is an integer multiple of 2, and two adjacent rows of squares are aligned, or two adjacent rows of squares are staggered, and m is a positive integer. The battle area is evenly divided into two parts based on the rows, which respectively are an allied battle area and an enemy battle area. In the preparation stage, the user places a piece in the allied battle area.

Virtual piece: It is a piece placed on a board in an auto chess game, and includes a battle virtual piece and a preparation virtual piece. The battle virtual piece is a virtual piece located in a battle area, and the preparation virtual piece is a virtual piece located in a preparation area.

In some embodiments, in the battle area, when different virtual pieces have the same attribute and a quantity reaches a preset value (also referred to as a fetter), a buff effect corresponding to the attribute may be obtained for a battle virtual piece having the attribute or for all battle virtual pieces in the battle area. For example, when the battle area includes 2 battle virtual pieces with a warrior attribute, a defense bonus of 10% is obtained for all battle virtual pieces; when the battle area includes 4 battle virtual pieces with a warrior attribute, a defense bonus of 20% is obtained for all battle virtual pieces; and when the battle area includes 3 battle virtual pieces with a fairy attribute, a dodge probability bonus of 20% is obtained for all battle virtual pieces.

Gold coin: It is a basic resource (virtual resource) configured for purchasing a piece, upgrading, and refreshing a shop in a battle. In each turn, base gold and 10% interest on the current gold (interest capped at 5; no interest when the number of gold coins is fewer than 10) are obtained. When a streak of consecutive wins or losses occurs, additional gold coins are obtained based on the consecutive wins (or losses).

Attribute: Based on different types of pieces, each type of piece has different attributes, different pieces may have the same attribute, and the attribute includes at least one of a grade and a star level. The grade is an inherent attribute of a piece, and is fixed. The star level is a non-inherent attribute of a piece, and the piece may increase the star level by star-raising. Attributes and skill strength are significantly improved after star-raising of a piece, and a highest star level of a piece is 3 stars.

Grade: It is an inherent attribute of a piece. Based on rarity and skills of the pieces, the pieces are divided into 1/2/3/4/5 grades, and corresponding purchase prices in the game store are respectively 1/2/3/4/5 gold coins.

Star-raising: When 3 matching pieces (having the same star level and grade) exist on a board and in a preparation area, they automatically synthesize into a piece of a higher star level, while the grade of the piece remains unchanged. This process is referred to as star-raising. For example, owning 3 matching pieces with star level 1 and grade 1 will automatically raise them into one piece with star level 2 and grade 1. Owning 3 matching pieces with star level 2 and grade 1 will automatically raise them into one piece with star level 3 and grade 1. The highest star level for a piece is star level 3, and a total of 9 pieces with star level 1 are required to create 1 piece with star level 3. A piece's attributes and skill strength are significantly improved after star-raising. A player can buy a piece with star level 1 in a game store, but cannot directly buy a piece with star level 2 or 3.

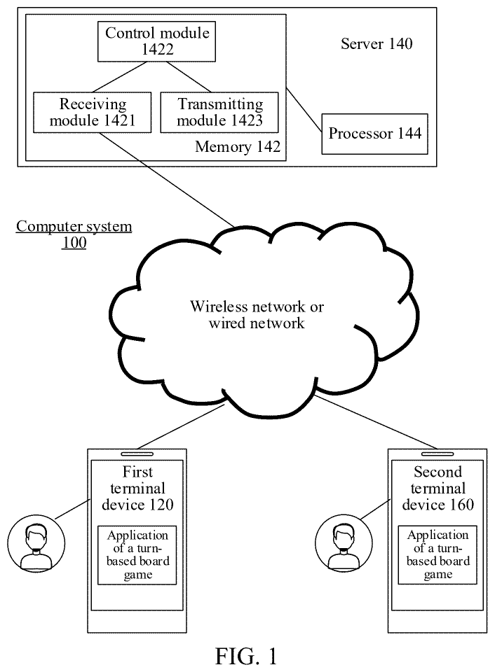

FIG. 1 is a structural block diagram of a computer system according to some embodiments. The computer system 100 includes a first terminal device 120, a server 140, and a second terminal device 160.

An application of a turn-based board game, for example, an auto chess game application, is installed and runs on the first terminal device 120. The first terminal device 120 is a terminal device used by a first user. The first user purchases a new virtual piece or sells an owned virtual piece through the first terminal device 120 in a preparation stage and/or a battle stage of a battle. The first user arranges a battle virtual piece in a battle area of a board through the first terminal device 120 in the preparation stage of the battle. The first terminal device 120 automatically controls the battle virtual piece to battle based on an attribute, a skill, and an arrangement of the battle virtual piece in the battle area in the battle stage.

The first terminal device 120 is connected to the server 140 through a wireless network or a wired network.

The server 140 includes at least one of one server, a plurality of servers, a cloud computing platform, and a virtualization center. The server 140 includes a processor 144 and a memory 142. The memory 142 further includes a receiving module 1421, a control module 1422, and a transmitting module 1423. The receiving module 1421 is configured to receive a request transmitted by a client, such as a viewing request about viewing a lineup of an enemy virtual piece. The control module 1422 is configured to control rendering of a virtual world picture. The transmitting module 1423 is configured to transmit a response to the client, for example, transmit the lineup of the enemy virtual piece to the client. The server 140 is configured to provide a background service for the application of the turn-based board game. In some embodiments, the server 140 is responsible for main calculation, and the first terminal device 120 and the second terminal device 160 are responsible for secondary calculation; or the server 140 is responsible for secondary calculation, and the first terminal device 120 and the second terminal device 160 are responsible for main calculation; or a distributed computing architecture is configured for collaborative computing among the server 140, the first terminal device 120, and the second terminal device 160.

An application of a turn-based board game, for example, an auto chess game application, is installed and runs on the second terminal device 160. The second terminal device 160 is a terminal device used by a second user. The second user purchases a new virtual piece or sells an owned virtual piece by using the second terminal device 160 in a preparation stage and/or a battle stage of a battle. The second user arranges a battle virtual piece in a battle area of a board by using the second terminal device 160 in the preparation stage of a battle. The second terminal device 160 automatically controls the battle virtual piece to battle based on an attribute, a skill, and an arrangement of the battle virtual piece in the battle area in the battle stage.

In some embodiments, the battle virtual pieces arranged by the first user through the first terminal device 120 and arranged by the second user through the second terminal device 160 are located in different battle areas on the same board. The first user and the second user are in the same battle.

In some embodiments, the application installed on the first terminal device 120 is the same as the application installed on the second terminal device 160, or the applications installed on the two terminal devices are the same type of applications on different operating system platforms. The first terminal device 120 may be one of a plurality of terminal devices, and the second terminal device 160 may be one of a plurality of terminal devices. In some embodiments, only the first terminal device 120 and the second terminal device 160 are used as an example for description. Device types of the first terminal device 120 and the second terminal device 160 may be the same or different. The device types include at least one of a smartphone, a tablet computer, an e-book reader, a digital player, a laptop portable computer, or a desktop computer. In the following embodiments, a description is provided using an example in which the terminal device includes the smartphone.

A person skilled in the art may understand that more or fewer terminal devices may be provided. For example, only one of the foregoing terminal devices (e.g., a user playing against artificial intelligence (AI)) may be included. Eight (1v1v1v1v1v1v1v1, where a round-robin battle and elimination is performed among the 8 users, and a final winner is determined) or more of the foregoing terminal devices may be included. A quantity of terminal devices and the device type are not limited in some embodiments.

A type of game in which a virtual piece is placed for a battle is collectively referred to as an auto chess game. A player performs a battle by using a virtual piece, and may obtain a win by defeating the virtual piece of an opponent. The auto chess game may be configured for the player to purchase the virtual piece for arranging.

In some auto chess games, a virtual object setting exists. The virtual object is a player-representing character that is movable and interactive, and has a function such as picking up an orb, equipping, and moving to obtain a piece in a selection turn in the game.

In some embodiments, the virtual object interacts with the virtual piece or a virtual board. For example, when the player moves the virtual piece, the virtual object performs a corresponding motion. When the virtual object reaches a corresponding position of the virtual board, the virtual board displays a corresponding board effect feedback or the like.

In some embodiments, in a selection stage, the player may move the virtual object to obtain the virtual piece. In a board, when an item or a trophy orb falls, the player moves the virtual object to pick up a corresponding orb.

The virtual object usually applies in the selection stage or an effect-based interaction with the virtual board or the virtual piece. The virtual object has no related interaction with an intra-turn battle process.

For the foregoing problem, some embodiments provide an interesting turn form related to a combat process, which enhances association between the virtual object and the battle, and changes from the original simple battle-watching to the player actively operating the virtual object in a turn to provide help for the battle, thereby enriching interest of the game, and reducing an original problem of a relatively tedious battle stage.

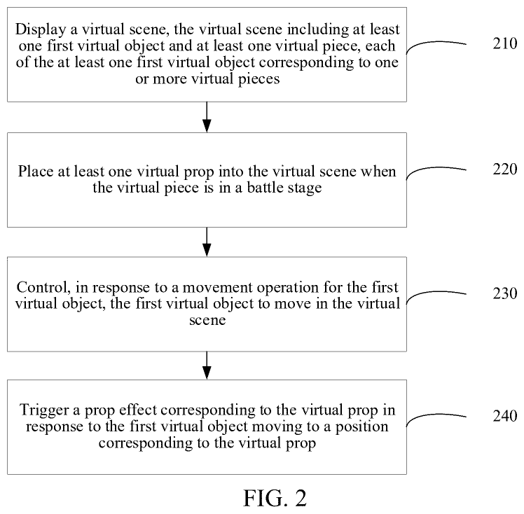

FIG. 2 is a flowchart of a method for controlling a virtual object according to some embodiments. The method is performed by a computer device. A description is provided by using an example in which the method is applied to the first terminal device 120 or the application of the turn-based board game installed on the first terminal device 120 or the second terminal device 160 or the application of the turn-based board game installed on the second terminal device 160 shown in FIG. 1. The method includes at least one operation of operation 210, operation 220, operation 230, and operation 240.

Operation 210: Display a virtual scene, the virtual scene including at least one first virtual object and at least one virtual piece, each of the at least one first virtual object corresponding to one or more virtual pieces.

In some embodiments, the computer device displays a scene of a turn-based virtual board game. One or more first virtual objects are displayed in the virtual scene.

In some embodiments, a first client of the turn-based board game application is installed on the first terminal device, and a second client of the turn-based board game application is installed on the second terminal device. In some embodiments, a first user account of a first user controls a first virtual object in a client of the turn-based board game application, and a second user account of a second user controls another first virtual object in the client of the turn-based board game application. In some embodiments, different first virtual objects are in the same virtual scene. In some embodiments, different first virtual objects may belong to the same camp, the same team, or the same organization, or may be friends, or may have temporary communication permission. In some embodiments, different first virtual objects may belong to different camps, different teams, or different organizations, or may be rivals. The first virtual object controlled by the second user is also considered as the following third virtual object.

The first virtual object represents a virtual object controlled by a player in a virtual scene, each player corresponds to a camp, and each camp corresponds to one or more virtual pieces. Each first virtual object corresponds to one or more virtual pieces.

In an example, two different camps are battled in a battle turn, and a virtual piece of one camp wins a virtual piece of the other camp, for example, a win of the battle turn may be obtained.

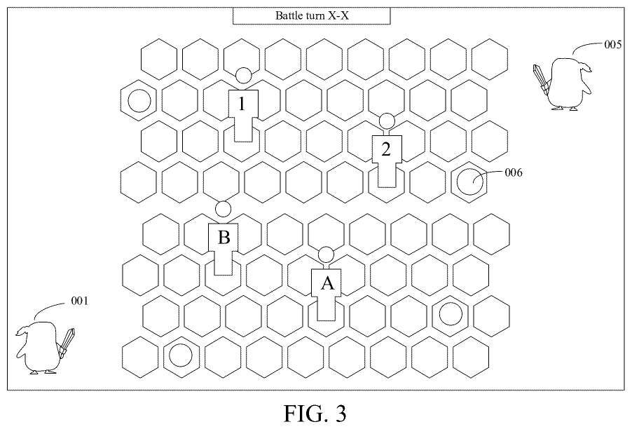

FIG. 3 is a schematic diagram of a battle turn according to some embodiments.

As shown in FIG. 3, the virtual scene includes two first virtual objects: a virtual object 001 and a virtual object 005. The virtual object 001 corresponds to virtual pieces A and B, and the virtual object 005 corresponds to virtual pieces 1 and 2. When entering a battle state, the virtual pieces A and B automatically battle with the virtual pieces 1 and 2.

Operation 220: Place at least one virtual prop into the virtual scene when the virtual piece is in a battle stage.

In some embodiments, when the virtual piece is in the battle stage, the computer device may display one or more virtual props in the virtual scene.

In some embodiments, at least one virtual prop is placed into the virtual scene only when the virtual piece is in the battle stage. At least one virtual prop is not placed into the virtual scene when the virtual piece is not in the battle stage.

The player may control the corresponding first virtual object to move to a position of the virtual prop, and pick up the corresponding virtual prop, to obtain a corresponding reward in the virtual prop.

In some embodiments, the virtual prop is a prop acting in the battle stage. The reward in the virtual prop may be configured for a current battle, to increase chances of win for the current battle. The virtual prop is a prop acting on a virtual object or a virtual piece corresponding to the virtual object in the battle stage.

As shown in FIG. 3, a plurality of virtual props, such as reward orbs 006, are displayed in the virtual scene, and both players may control a corresponding virtual object 001 or virtual object 005 to pick up any one or more reward orbs 006.

In an example, the virtual prop may be in a form of an orb, a package, a box, or the like.

In an example, a corresponding reward in the virtual prop may be a reward beneficial to the battle, such as a gold coin, a piece, an item, or a buff.

In an example, the virtual prop may be directly released by the computer device or placed through a virtual interaction object or a virtual interaction apparatus, to increase interest and interaction of a virtual game.

In some embodiments, the battle stage includes one or more battle turns. Operation 220 may be implemented as:
displaying at least one virtual prop in the virtual scene in response to a specified one of the one or more battle turns to start.

In some embodiments, the battle stage includes at least one battle turn. When the specified battle turn in the battle turns starts, one or more virtual props are displayed in the virtual scene.

One battle stage may include a plurality of battle turns, and the computer device may designate one or more battle turns therein to place the virtual prop.

The computer device may display the virtual prop in some battle turns in the battle stage.

One battle stage includes eight battle turns. The computer device randomly designates three battle turns as turns. The virtual prop is displayed in the turns.

Different turns may display different virtual props.

A preparation stage exists before each battle turn. In the preparation stage, the player may prepare a virtual piece that may be battled in a next battle turn.

The reward in the virtual prop may be configured for a current battle turn. After controlling the first virtual object to pick up the virtual prop, the player may increase the chances of win for the current battle turn.

Some embodiments provide timing for placing the virtual prop. The virtual prop is placed in a specified battle turn to improve interest and interaction in the virtual game and to add a new interactive gameplay while preserving the existing gameplay.

Operation 230: Control, in response to a movement operation for the first virtual object, the first virtual object to move in the virtual scene.

In some embodiments, when receiving a movement operation performed by the player on the first virtual object, in response to the movement operation, the computer device controls the first virtual object to move to a corresponding position.

In some embodiments, when the player meets a particular condition related to the movement operation, in response to the movement operation, a moving speed of the first virtual object may be increased so that the first virtual object may quickly pick up the virtual prop, which is a bonus for the battle.

In some embodiments, the movement operation for the first virtual object is an operation configured for moving the first virtual object, and the movement operation for the first virtual object includes, but is not limited to, a click/tap operation, a touch-and-hold operation, a drag operation, and the like on a moving control on a user interface (UI). In some embodiments, the movement operation for the first virtual object is an operation directly for the terminal device. In some embodiments, the movement operation for the first virtual object is an operation for an external device of the terminal device. The external device of the terminal device refers to a device that is directly connected or indirectly connected to the terminal device. The external device of the terminal device includes, but is not limited to, at least one of the following: a mouse, a gamepad, or a touchscreen. The operation for the external device of the terminal device is considered a movement operation for the first virtual object. In response to a drag operation for a joystick on the gamepad, it is considered that the drag operation is the movement operation for the first virtual object. In response to a movement operation for the mouse, it is considered that the movement operation is the movement operation for the first virtual object. In response to a sliding operation for the touchscreen, it is considered that the sliding operation is the movement operation for the first virtual object.

Operation 240: Trigger a prop effect corresponding to the virtual prop in response to the first virtual object moving to a position corresponding to the virtual prop.

In some embodiments, after the player controls the first virtual object to move to the corresponding position of the virtual prop, the first virtual object may obtain the virtual prop, and trigger a prop effect corresponding to the virtual prop. The prop effect is an effect generated by the virtual prop. The prop effect is an effect that acts on at least one of the virtual piece, the first virtual object, the virtual scene, and the like.

In some embodiments, the prop effect includes at least one of the following effects:
releasing a virtual resource, restoring an attribute value of the virtual piece, increasing the virtual piece, releasing a virtual item, refreshing a quantity of times the virtual piece is purchasable, refreshing a skill cool-down duration of the virtual piece, and applying a buff effect to the virtual piece.

In some embodiments, after the player controls the first virtual object to pick up the virtual prop, the virtual reward that can be obtained may include:
a virtual resource, which may be configured for purchasing a piece, upgrading, refreshing a virtual store, and the like;
recovering attribute values of a virtual piece, including a grade, a star level, a hit point, a magic value, and the like;
a virtual piece, for example, a virtual piece can be obtained without purchasing by a virtual resource;
virtual item, which may be a bonus for an existing skill point of a virtual piece, or add a new skill point;
a quantity of refreshes, for example refreshing the virtual store for free to buy more virtual pieces;
refreshing a skill cool-down duration, so that a cooling skill of the virtual piece is recovered, or a cooling duration is shortened; and
a buff effect, which enables the virtual piece to obtain a buff, for example, increasing an overall attack power, ability power, an attack speed of the virtual pieces, or the like.

In some embodiments, only the foregoing virtual reward is used as an example for description. In some embodiments, the foregoing virtual reward may include more types of rewards, which is not limited in some embodiments.

Some embodiments provide a prop-effect feasibility solution. The player may move the first virtual object to pick up the virtual props to trigger different prop effects and obtain a plurality of different virtual rewards, thereby increasing the chances of winning the battle. The diversity of the virtual props is enriched, and the uncertainty of the game is increased.

Based on the above, according to the method for controlling a virtual object provided in some embodiments, in the auto chess game scene, the computer device may display the virtual scene including the first virtual object and the virtual piece, and display at least one virtual prop in the virtual scene when the virtual piece is in the battle stage. The first virtual object may be controlled to move in response to the received movement operation for the first virtual object, and a prop effect corresponding to the virtual prop is triggered when the first virtual object moves to the position corresponding to the virtual prop. In the foregoing solution, when the virtual piece is in the battle, the obtained virtual prop that may be operated by the player is placed in the scene, and after obtaining the virtual prop, the player may increase a win rate for the battle. The method provides an interaction mode in the auto chess battle, enriches manners for controlling the virtual object, and can reduce tedium of a player having to wait for an outcome of the battle of the virtual pieces during the battle. The virtual prop may increase uncertainty of the outcome of the battle, which helps the player adjust a game strategy of the virtual pieces during the battle, thereby improving interactivity of the auto chess game.

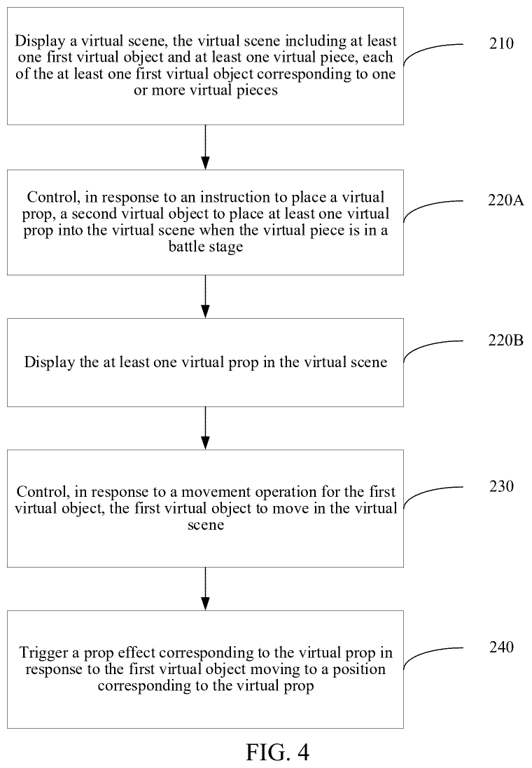

Based on the method shown in FIG. 2, FIG. 4 is a flowchart of a method for controlling a virtual object according to some embodiments. Operation 220 may be implemented as the following operations 220A and 220B. In some embodiments, the virtual scene further includes a second virtual object, and the second virtual object is different from the first virtual object.

In some embodiments, the computer device displays the second virtual object in the virtual scene, to prompt the player that the player has entered a turn.

In some embodiments, at least one virtual prop is placed into the virtual scene by the second virtual object after receiving an instruction to place the at least one virtual prop.

The second virtual object may appear at the preparation stage, so that the player may adjust the virtual piece for the battle.

Operation 220A: Control, in response to the instruction to place the virtual prop, the second virtual object to place at least one virtual prop into the virtual scene when the virtual piece is in the battle stage.

In some embodiments, when the virtual piece is in the battle stage and an instruction to place a virtual prop is received, the computer device places at least one virtual prop in response to the instruction and displays an animation of the second virtual object placing the corresponding virtual prop.

The animation of the second virtual object placing the virtual prop may be indicated by a dynamic path from the second virtual object to a placement position. While the animation is displayed, the player may move the first virtual object in advance along a predetermined path.

The instruction to place the virtual prop may be preset by a developer in the computer device. The instruction may be released randomly or triggered at predetermined times during the battle, for example, when any virtual piece is defeated, or at the third second, fifth second, or other specified time after the battle starts.

In some embodiments, the instruction to place the virtual prop may be user-triggered or automatically triggered. The computer device sets trigger conditions for the instruction to place the virtual prop. The trigger conditions include, but are not limited to, at least one of the following: receiving a trigger operation for a placement control on a UI, a battle-stage duration reaching a first duration, or a quantity of virtual pieces configured for the battle reaching a first quantity. When the trigger condition is the receipt of a trigger operation for the placement control on the UI, the instruction is user-triggered. When the trigger condition is that the battle-stage duration reaches the first duration, or that the quantity of virtual pieces reaches the first quantity, the instruction may be automatically triggered by the computer device. The first duration and the first quantity are preset.

In some embodiments, based on different control methods, virtual objects may be divided into a user-controlled virtual object and a server-controlled virtual object. A user-controlled virtual object is controlled by a client and may move in the virtual scene. A server-controlled virtual object is controlled by an automatic control algorithm or an AI program on a client or on a server. The server-controlled virtual object may be movable or immovable in the virtual scene. An immovable object may respond to or affect the activity of a movable object. For example, the movable object may destroy the immovable object, or when the movable object enters the immovable object, the movable object enters an invisible state. In some embodiments, the first virtual object is controlled by the client. The second virtual object may be controlled by another client or by the server. The third virtual object may also be controlled by another client or by the server.

The second virtual object may be a server-controlled virtual object, also referred to as an AI virtual object, for example, an NPC. The second virtual object may be a virtual interaction object or a virtual interaction apparatus.

Operation 220b: Display the at least one virtual prop in the virtual scene.

In some embodiments, the computer device displays the corresponding virtual prop in the virtual scene.

The virtual prop is displayed at the position where the second virtual object places it in operation 220A.

In some embodiments, controlling the second virtual object to place the virtual prop into the virtual scene can not only enrich the visuals of the auto chess game but also help the player adjust game strategy in a timely manner.

In some embodiments, the virtual scene further includes a virtual board, the virtual board being divided into a plurality of virtual squares, with each virtual piece located in a corresponding virtual square.

In some embodiments, the computer device displays, in the virtual scene, a virtual board including a plurality of virtual squares, and each virtual piece is located in a corresponding virtual square.

The virtual board includes n rows×m columns of virtual squares, where n is an integer multiple of 2, and adjacent rows of squares are either aligned or staggered.

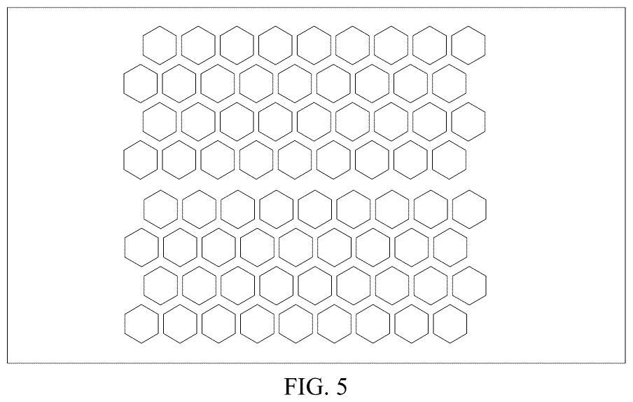

FIG. 5 is a schematic diagram of a virtual board according to some embodiments. As shown in FIG. 5, the virtual board includes 8 rows×9 columns of virtual squares, and adjacent rows of squares are staggered.

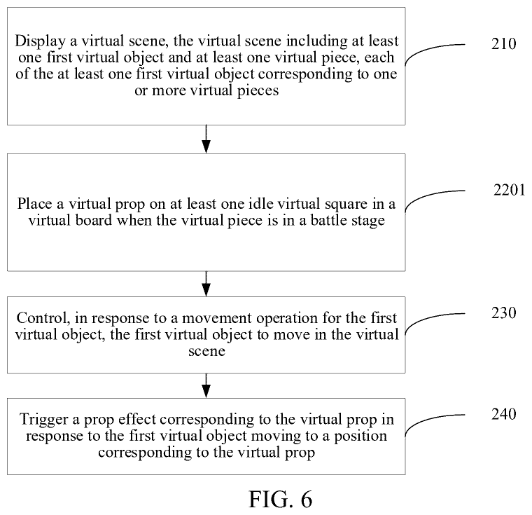

Based on the method shown in FIG. 2, FIG. 6 is a flowchart of a method for controlling a virtual object according to some embodiments. The foregoing operation 220 may be implemented as operation 2201.

Operation 2201: Place a virtual prop on at least one idle virtual square on the virtual board when the virtual piece is in the battle stage.

In some embodiments, the virtual scene further includes a virtual board, the virtual board being divided into a plurality of virtual squares, with each virtual piece located in a corresponding virtual square.

In some embodiments, when the virtual piece is in the battle stage, the computer device displays the virtual prop in one or more idle virtual squares.

An idle virtual square is a virtual square in which no virtual piece exists.

The computer device determines whether idle virtual squares exist on the virtual board and, if so, respectively displays one virtual prop in one or more idle virtual squares.

In response to the instruction to place the virtual prop when the virtual piece is in the battle stage, the second virtual object is controlled to place one virtual prop on each idle virtual square among the at least one idle virtual square on the virtual board.

A quantity of virtual props placed each time is preset. One virtual prop may be placed in one idle virtual square. When the quantity of virtual props to be placed is N, N idle virtual squares are needed to place the N virtual props, where N is a positive integer. Alternatively, a plurality of virtual props may be placed in one idle virtual square. When the quantity of virtual props to be placed is N, M idle virtual squares are needed to place the N virtual props, where N is a positive integer and M is a positive integer less than N.

Some embodiments provide a feasible placement-position solution for virtual props. Only when an idle virtual square exists on the virtual board will a virtual prop be displayed at the corresponding position. This solution helps ensure visual simplicity and smoothness in the virtual scene and avoids visual disturbance caused by excessive on-screen elements.

In some embodiments, operation 2201 may be implemented as operations 2201A and 2201B.

Operation 2201A: Display a first marking element on the at least one idle virtual square when the virtual piece is in the battle stage, the first marking element indicating that the corresponding idle virtual square is configured for placement of the virtual prop.

Operation 2201B: Place a virtual prop on the at least one idle virtual square when the display of the first marking element ends.

In some embodiments, when the virtual piece is in the battle stage, the computer device displays the first marking element on one or more virtual squares in which the virtual prop is to be displayed, to prompt the player that the virtual prop is about to appear in the virtual square.

In some embodiments, the first marking element indicates that the corresponding idle virtual square is configured for placement of the virtual prop. The first marking element may be a distinguishable shape mark in the virtual square, an animation displayed in the virtual square, or a distinguishable color mark in the virtual square.

After the display of the first marking element is completed, the virtual prop is displayed on the one or more virtual squares in which the first marking element was displayed.

The computer device may display the virtual prop on all of the virtual squares, or on only some of the virtual squares, in which the first marking element was displayed.

Some embodiments provide a virtual-prop prompt solution. Before displaying the virtual prop in a virtual square, the first marking element is first displayed in the corresponding virtual square to prompt the player that the virtual prop is about to appear. In this solution, placement of the virtual prop is preceded by a prompt to the player, helping the player adjust game strategy in time.

In some embodiments, the first marking element is further configured to indicate a prop effect associated with the virtual prop placed in the corresponding idle virtual square.

In some embodiments, the first marking element may further indicate, to the player, the prop effect of the virtual prop to be displayed in the corresponding virtual square.

Different prop effects may be distinguished through displayed numbers, colors, pictures, or animations.

In some embodiments, virtual props corresponding to different prop effects may be displayed with different marking effects, so that the player can learn in advance which virtual prop is about to appear. When multiple virtual props appear simultaneously, the player may identify them through the first marking elements and move toward the virtual square containing the virtual prop that provides the desired prop effect.

In some embodiments, the prop effect includes applying a buff effect to a virtual piece.

In some embodiments, the buff effect is applied to virtual pieces in a first area of the virtual scene. The first area includes at least one of the following: an area centered on the first virtual object, a preset area, or an area selected by a user.

The first area may be an area centered on the first virtual object, such as a circular area centered on the first virtual object with a preset radius.

The first area may be a preset area, for example, an area preset in at least one of a central area, an upper left corner, a lower left corner, an upper right corner, or a lower right corner of the virtual scene.

The first area may be an area selected by the user. Before the prop effect of the virtual prop is triggered, a selection control is displayed on a UI to allow the user to select the first area. After the user selects the first area, the buff effect is applied to the virtual pieces in the first area.

After the first area is determined, the computer device determines the virtual pieces in the first area and applies the buff effect to the virtual pieces in the first area.

In the technical solution provided in some embodiments, applying the buff effect to virtual pieces in the first area enriches the prop effect of the virtual prop. The first area may be centered on the first virtual object, or it may be a preset or user-selected area. The forms of determining the first area are diversified, thereby enriching human-machine interaction.

In some embodiments, the buff effect is applied to a first type of virtual piece in the first area of the virtual scene.

In some embodiments, a debuff effect corresponding to the buff effect is applied to a second type of virtual piece in the first area of the virtual scene.

The first type of virtual piece includes at least one virtual piece corresponding to the first virtual object. The second type of virtual piece includes at least one virtual piece corresponding to a third virtual object, where the third virtual object is a virtual object battling with the first virtual object during the battle stage.

After the first area is determined, the virtual pieces in the first area are obtained. It is assumed that, during the battle stage, the virtual scene includes two battle parties, for example, at least one virtual piece corresponding to the first virtual object and at least one virtual piece corresponding to the third virtual object. Because the third virtual object battles with the first virtual object during the battle stage, when applying a buff effect to virtual pieces in the first area, the virtual pieces corresponding to the first virtual object may be distinguished from those corresponding to the third virtual object.

In a first application manner, the buff effect is applied only to the first type of virtual piece in the first area of the virtual scene. That is, the buff effect is applied only to the virtual pieces corresponding to the first virtual object in the first area.

In a second application manner, the debuff effect is applied only to the second type of virtual piece in the first area of the virtual scene. That is, the debuff effect is applied only to the virtual pieces corresponding to the third virtual object in the first area.

In a third application manner, the buff effect is applied to the first type of virtual piece in the first area of the virtual scene, and the debuff effect is applied to the second type of virtual piece in the first area of the virtual scene. That is, the buff effect is applied to the virtual pieces corresponding to the first virtual object in the first area, and the debuff effect is applied to the virtual pieces corresponding to the third virtual object in the first area.

The debuff effect corresponding to the buff effect is an effect opposite to the buff effect. For example, a buff effect may increase the overall attack power, ability power, or attack speed of the virtual pieces, while a debuff effect may reduce the overall attack power, ability power, or attack speed of the virtual pieces.

Before the buff effect or the debuff effect is applied, a prompt interface is displayed to the user. The prompt interface allows the user to select at least one of the first to third application manners. The prompt interface includes three options, respectively corresponding to the first through third application manners. After one of the three options is selected, the corresponding application manner is triggered.

In the technical solution provided in some embodiments, the buff effect is applied to the first type of virtual piece in the first area of the virtual scene, and the debuff effect corresponding to the buff effect is applied to the second type of virtual piece in the first area. This enriches the application forms of the prop effect and helps improve the interest of the battle. The user may select the application manner, thereby enriching human-machine interaction.

In some embodiments, the foregoing operation 240 may be implemented as:
triggering a prop effect corresponding to a first virtual prop when the first virtual object moves to a first virtual square where the first virtual prop is located, the first virtual prop being one of the at least one virtual prop; or
triggering, in response to a trigger operation for a second virtual prop, a prop effect corresponding to the second virtual prop when the first virtual object moves to a second virtual square, the second virtual square being adjacent to a virtual square where the second virtual prop is located, the second virtual prop being another one of the at least one virtual prop different from the first virtual prop.

The trigger operation for the second virtual prop is an operation configured to trigger the second virtual prop. The trigger operation for the second virtual prop includes, but is not limited to, a click/tap operation, a double-click/double-tap operation, or a touch-and-hold operation for the second virtual prop.

In some embodiments, when the player controls the first virtual object to move to the virtual square where a virtual prop is located, or to a virtual square adjacent to the virtual square where the virtual prop is located, the computer device triggers the prop effect of the virtual prop.

The adjacent virtual squares of the first virtual square include not only the virtual squares adjacent to the first virtual square in the same row but also the virtual squares adjacent to the first virtual square in the same column.

Some embodiments provide a triggering-timing solution for the prop effect corresponding to a virtual prop. When the player controls the first virtual object to move to the virtual square where the virtual prop is located, or to an adjacent virtual square, the virtual prop may be obtained. This solution provides a constraint condition for triggering timing and can increase interactivity when the player obtains the virtual prop in the auto chess game, thereby enriching human-machine interaction.

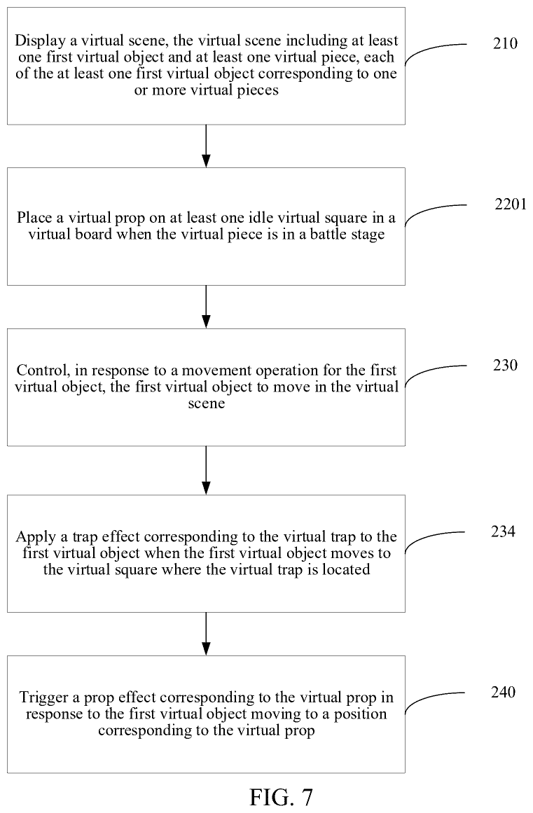

Based on the method shown in FIG. 6, FIG. 7 is a flowchart of a method for controlling a virtual object according to some embodiments. Operation 234 is further included before operation 240.

In some embodiments, the virtual scene further includes a virtual board, the virtual board being divided into a plurality of virtual squares. The virtual scene further includes a virtual trap, the virtual trap being located in a corresponding virtual square. In some embodiments, operation 232 may further be included before operation 234. Operation 232: Display the virtual trap in the virtual scene.

Operation 234: Apply a trap effect corresponding to the virtual trap to the first virtual object when the first virtual object moves to the virtual square where the virtual trap is located.

In some embodiments, the computer device may display, in the virtual scene, a virtual trap configured to increase difficulty. When the player controls the first virtual object to move to the virtual square where the virtual trap is located, the trap effect corresponding to the virtual trap is applied to the first virtual object, preventing the player from obtaining the virtual prop by controlling the first virtual object.

In some embodiments, the virtual trap is a virtual object configured to act on a virtual piece or on the first virtual object in the virtual scene, thereby making it more difficult to win a battle. The virtual trap acts on the virtual piece or the first virtual object to generate a negative effect. The trap effect is an effect generated by the virtual trap on the virtual piece or on the first virtual object.

The virtual trap and the virtual prop may appear simultaneously; may appear from the moment the player begins moving the first virtual object; or may appear randomly while the player is moving the first virtual object.

Some embodiments provide a feasible solution for increasing the difficulty of obtaining the virtual prop, including displaying a virtual trap in the virtual scene and applying a corresponding penalty to the first virtual object if the virtual trap is triggered by the first virtual object. This solution can add interest to the auto chess game and add uncertainty to the process of obtaining the virtual prop.

In some embodiments, the foregoing operation 232 may be implemented as operation 232A.

Operation 232A: Operation 232A: Display one virtual trap in at least one idle virtual square on the virtual board, the virtual square where the virtual trap is located being different from a virtual square where a virtual prop is located.

In some embodiments, the computer device displays the virtual trap in one or more idle virtual squares.

The virtual square where the virtual trap is displayed is different from the virtual square where the virtual prop is displayed.

An idle virtual square herein is a virtual square in which no virtual piece and no virtual prop exist.

The computer device determines whether idle virtual squares exist on the virtual board and, if so, respectively displays one virtual trap in one or more idle virtual squares.

Some embodiments provide a feasible placement-position solution for a virtual trap. Only when an idle virtual square exists on the virtual board will the virtual trap be displayed at the corresponding position. This solution helps ensure visual simplicity and smoothness in the virtual scene and avoids visual disturbance caused by excessive on-screen elements. The virtual square where the virtual trap is located is different from the virtual square where the virtual prop is located, thereby avoiding the virtual prop and the virtual trap appearing simultaneously in the same virtual square.

In some embodiments, operation 232A may be implemented as operations 232A1 and 232A2.

Operation 232A1: Display a second marking element in at least one idle virtual square, the second marking element indicating that the corresponding virtual square is configured for display of the virtual trap.

Operation 232A2: Display one virtual trap in at least one idle virtual square when the display of the second marking element ends.

In some embodiments, the computer device displays the second marking element on one or more virtual squares in which the virtual trap is to be displayed, to prompt the player that the virtual trap is about to appear in the virtual square.

The second marking element and the first marking element are completely different and can be distinguished by the player, to prevent the player from confusing the two marking elements and causing the first virtual object to mistakenly enter the virtual trap.

In some embodiments, the second marking element indicates that the corresponding virtual square is configured for display of the virtual trap. The second marking element may be a distinguishable shape mark in the virtual square, an animation displayed in the virtual square, or a distinguishable color mark in the virtual square.

After the second marking element is displayed, the virtual trap is displayed on the one or more virtual squares in which the second marking element was displayed.

The computer device may display the virtual trap on all of the virtual squares, or on only some of the virtual squares, in which the second marking element was displayed.

Some embodiments provide a virtual-trap prompt solution. Before the virtual trap is displayed in a virtual square, the second marking element is first displayed in the corresponding virtual square to prompt the player that the virtual trap is about to appear. In this solution, the player is prompted when the virtual trap is placed, helping the player adjust the moving direction of the first virtual object in time so that the player may avoid the virtual trap.

In some embodiments, the second marking element is further configured to indicate the trap effect of a virtual trap for which the corresponding virtual square is configured. In some embodiments, the second marking element is further configured to indicate the trap effect of a virtual trap to be displayed in the corresponding virtual square.

In some embodiments, the second marking element may further indicate, to the player, the trap effect of the virtual trap to be displayed in the corresponding virtual square.

Different trap effects may be distinguished through displayed numbers, colors, pictures, or animations.

In some embodiments, virtual traps corresponding to different trap effects may be displayed with different marking effects, so that the player can learn in advance which virtual trap is about to appear. When one or more virtual traps appear, the player may anticipate the virtual traps through the second marking element and avoid triggering them. This both enriches visual display effects and enhances human-machine interaction.

In some embodiments, the trap effect includes at least one of the following: prohibiting the first virtual object from moving in the virtual scene, reducing a movement speed of the first virtual object, or reducing a hit point of the first virtual object.

In some embodiments, prohibiting the first virtual object from moving in the virtual scene includes prohibiting movement for a period of time. The period of time is a preset duration.

In some embodiments, when the player controls the first virtual object to move to the virtual square where the virtual trap is located, the trap effect includes one of the following: the player cannot control movement of the first virtual object within a set time, and movement is restored when the set time ends; the movement speed of the first virtual object is reduced within the set time, and the movement speed is restored when the set time ends; or the hit point of the first virtual object is reduced within the set time, and the hit point is restored when the set time ends.

The trap effect may include, for example, imprisoning the first virtual object for 3 seconds, or reducing the movement speed of the first virtual object by 60% within 5 seconds of triggering the virtual trap.

Some embodiments provide a feasible trap-effect solution. During movement of the first virtual object, a virtual trap that negatively impacts the player is set, thereby increasing uncertainty in the game. The virtual trap may have multiple different trap effects and can cause different negative impacts on the player, reflecting the diversity of the virtual trap and enriching human-machine interaction.

In some embodiments, the virtual square where the virtual trap is located is adjacent to the virtual square where the virtual prop is located; or the virtual square where the virtual trap is located lies on a predetermined path, the predetermined path being a shortest path between the position of the first virtual object and the virtual square where the virtual prop is located.

In some embodiments, the computer device may set the virtual trap in a virtual square adjacent to the virtual square where the virtual prop is located; or it may obtain the positions of the first virtual object and the virtual prop, calculate the shortest path from the first virtual object to the virtual prop, and set the virtual trap on the shortest path. The shortest path is the predetermined path.

For example, if the virtual prop is displayed in the virtual square in the second row and third column of the virtual board, the computer device may set the virtual trap in the virtual square in the second row and fourth column.

A quantity of virtual squares to be traversed from the virtual square where the first virtual object is located to the virtual square where the virtual prop is located is determined. Different paths may have different quantities of traversed virtual squares. The first virtual object can move only along a row or a column of the virtual board, one virtual square at a time. The path that traverses the smallest quantity of virtual squares from the virtual square where the first virtual object is located to the virtual square where the virtual prop is located is considered the shortest path.

A connecting line between the point in the virtual square where the virtual prop is located that is closest to the position of the first virtual object and the position of the first virtual object is considered a nearest path, for example, the shortest path. The virtual square through which the shortest path passes is considered the virtual square where the virtual trap is to be placed.

Some embodiments provide a feasible display-position solution for a virtual trap, including a position adjacent to the virtual prop and a predetermined path obtained by calculation based on the positions of the virtual prop and the first virtual object. This provides multiple options for the placement position of the virtual trap, thereby increasing uncertainty during the battle stage.

In some embodiments, the method shown in FIG. 7 further includes hiding the virtual trap in response to the display duration of the virtual trap reaching a specified duration and the virtual trap not being triggered.

In some embodiments, a specified display duration for virtual traps is set. When the display duration of a virtual trap reaches the specified duration and the trap is not triggered by the first virtual object, the computer device cancels display of the virtual trap and hides it. In some variants, the hidden virtual trap is not displayed again and can no longer be triggered by the first virtual object. In other variants, the hidden virtual trap may be redisplayed after a set duration and may be triggered by the first virtual object, with its trap effect attenuated. An attenuation degree is determined by an attenuation coefficient, and the product of the original trap effect and the attenuation coefficient is the effect of the redisplayed trap. The attenuation coefficient is negatively correlated with the duration for which the virtual trap is hidden: a longer hidden duration yields a smaller attenuation coefficient and greater attenuation; a shorter hidden duration yields a larger attenuation coefficient and smaller attenuation. The attenuation coefficient ranges from 0 to 1.

A developer may preset, in the computer device, the specified duration for the virtual trap.

Some embodiments provide a timing solution for hiding a virtual trap. The virtual trap is hidden when it is not triggered within the specified duration. This solution can ensure visual simplicity and smoothness in the virtual scene, and unnecessary display content is automatically hidden, thereby avoiding visual disturbance caused by excessive display content.

At the selection stage, the effect of moving the virtual object to obtain a virtual piece is relatively strong, making the selection sequence intense and exciting and providing a favorable user experience and feedback. It is also verified that virtual-object interaction can enhance the tension and excitement of the battle, thereby improving enjoyment.

The configuration of the virtual object has relatively little impact on the overall battle and lacks an interaction method related to battle properties. Some embodiments provide a new interaction form where, for example, an NPC character appears in a particular round. The NPC character throws a corresponding orb onto an idle position on the virtual board, and the player may pick up the orb by moving the virtual object to obtain a corresponding resource or a buff effect. For example, the orb may be a gold coin orb, an item orb, or a buff-type orb, which can increase the overall attack power, ability power, attack speed, or the like of the virtual pieces.

As an example, the method for controlling a virtual object provided in some embodiments is described in detail using its application to an auto chess game.

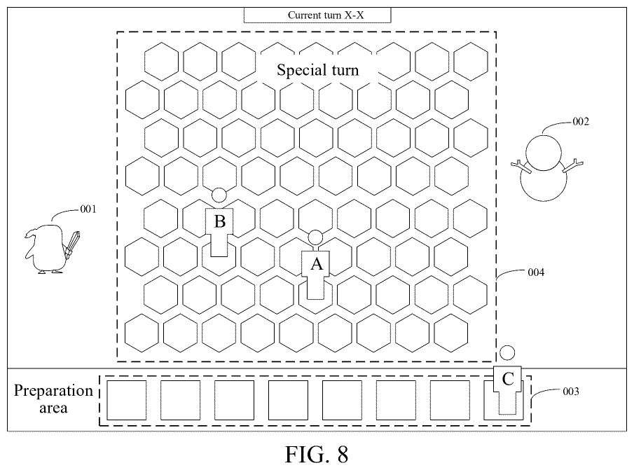

FIG. 8 is a schematic diagram of a virtual scene of a preparation stage according to some embodiments.

As shown in FIG. 8, a virtual object 001 exists in the virtual scene to represent one player. At the preparation stage, a corresponding NPC 002 (for example, the foregoing second virtual object) is displayed in the virtual scene to prompt the player that a special turn is beginning.

The board is divided into a preparation area 003 and a battle area 004. Virtual squares exist in both the preparation area 003 and the battle area 004 for players to place virtual pieces. One part of the virtual squares in the battle area 004 is configured for one player to place virtual pieces, and another part of the virtual squares is configured to display the virtual pieces of an opposing player during the battle stage.

In the preparation stage, the player may adjust their battle strategy, including selling a virtual piece in the preparation area 003, dragging a virtual piece from the preparation area 003 to the battle area 004, dragging a virtual piece from the battle area 004 to the preparation area 003, or replacing an item for a virtual piece.

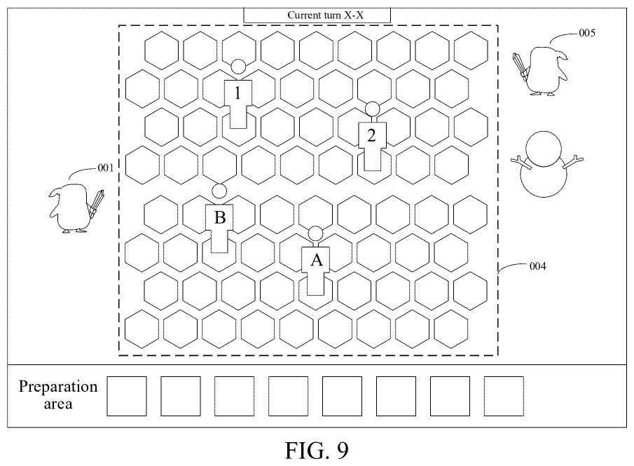

FIG. 9 is a schematic diagram of an interface of a battle stage according to some embodiments.

As shown in FIG. 9, a virtual object 005 arrives at the site (the party to which the virtual object 001 belongs is the home team or “main site”). The virtual object 001 and the virtual object 005 are enemies, and after the battle turn begins, the virtual pieces of the two parties start to battle.

The virtual squares in the battle area 004 respectively display battle pieces A, B, and the like of the virtual object 001 and battle pieces 1, 2, and the like of the virtual object 005.

The battle is divided into a main site and a guest site. If the party to which the virtual object 001 belongs is the guest site, that party travels to the other site for the battle, and the battle logic remains unchanged.

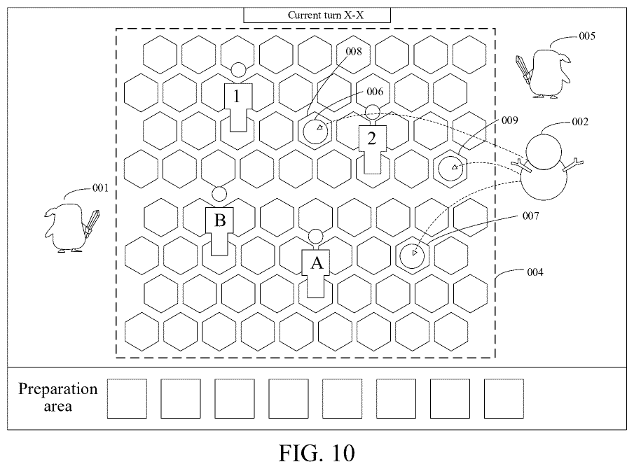

FIG. 10 is a schematic diagram of an interface of an NPC placing a reward according to some embodiments.

After a battle starts, an NPC 002 randomly places a reward orb 006 onto a virtual square in the battle area 004. As shown in FIG. 10, the NPC 002 places the reward orb 006 in virtual squares 007, 008, and 009.

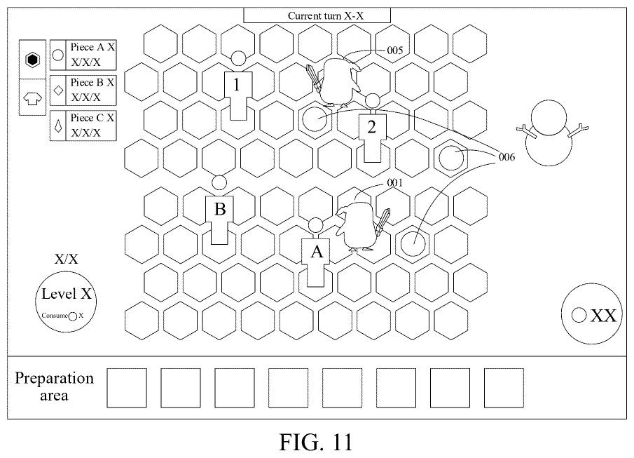

FIG. 11 is a schematic diagram of an interface of a virtual object picking up a reward according to some embodiments.

As shown in FIG. 11, the player may manipulate their virtual character (a virtual object 001 or a virtual object 005) to move to the corresponding position of the reward orb 006 to obtain it.

The reward orb 006 randomly carries a reward such as a virtual gold coin, a virtual piece, or a temporary buff effect for the turn. After moving a corresponding virtual object and picking up the reward orb 006, the player obtains the reward corresponding to that reward orb.

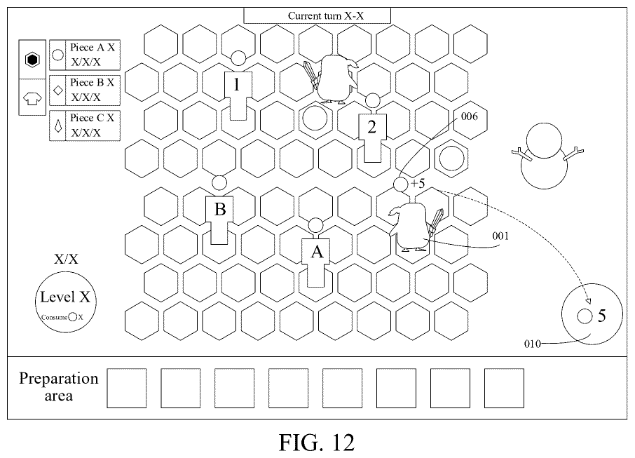

FIG. 12 is a schematic diagram of an interface of a virtual object obtaining a reward according to some embodiments.

As shown in FIG. 12, after picking up the reward orb 006 in the virtual square 007, the virtual object 001 obtains a virtual gold coin reward. The number of gold coins possessed by the player corresponding to the virtual object 001 is increased accordingly and displayed in a gold coin bar 010 of the virtual interface.

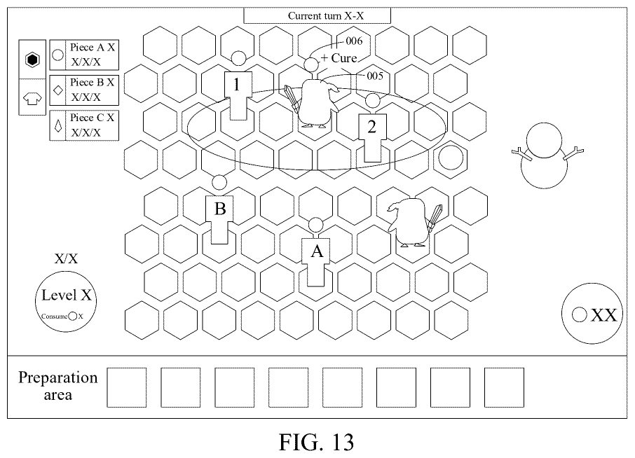

FIG. 13 is a schematic diagram of an interface of a virtual object obtaining a reward according to some embodiments.

As shown in FIG. 13, after picking up the reward orb 006 in the virtual square 008, the virtual object 005 obtains a healing buff, and the virtual piece corresponding to the virtual object 005 triggers an area-of-effect heal. An animation of the healing effect is displayed in the virtual interface, and the virtual piece corresponding to the virtual object 005 replenishes its hit points.

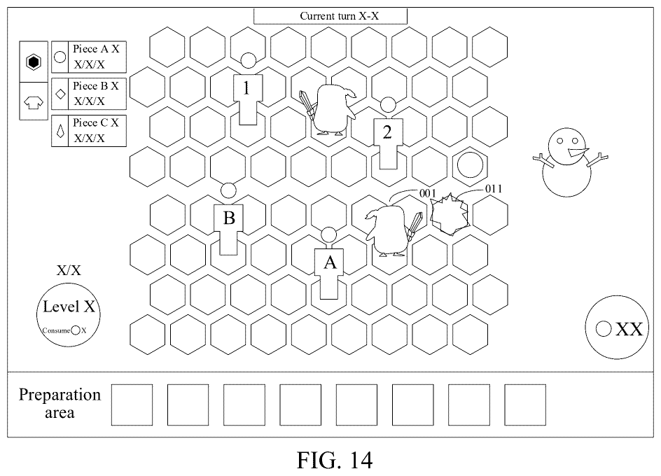

FIG. 14 is a schematic diagram of an interface of placing a virtual trap according to some embodiments.

To increase the difficulty of obtaining the reward, a trap may be set in a virtual square on a path from which the virtual object reaches the corresponding reward orb 006. When the player controls the virtual object to reach the trap square, the virtual object triggers the trap. For example, for a period of time, the virtual object is rendered immovable.

As shown in FIG. 14, a virtual trap 011 is displayed in an idle square near the virtual object 001.

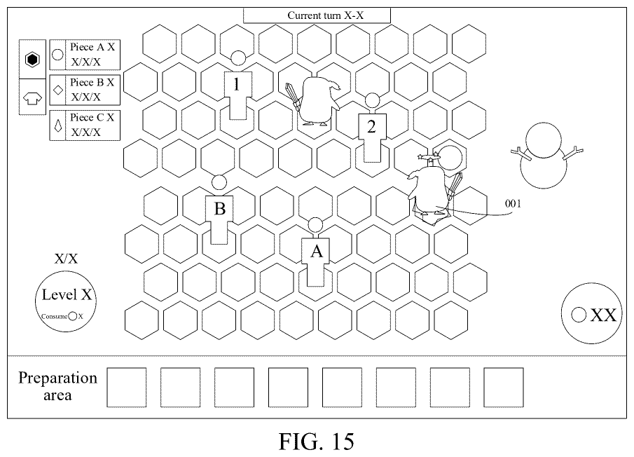

FIG. 15 is a schematic diagram of an interface of a virtual object triggering a trap according to some embodiments.

As shown in FIG. 15, the virtual object 001 triggers a virtual trap 011, the virtual object 001 is stunned, and an animation with a stun effect is displayed at a corresponding position in the virtual scene.

In view of the potential for intra-turn virtual object interaction, some embodiments provide a method of supporting a player to obtain a reward by controlling a virtual object in a turn stage of a battle stage. In a particular turn, a particular NPC places a reward prop on the site. The reward prop is placed in an idle square, and the player may move to that square to obtain a resource.

Prompts may be displayed when squares appear. If reward props appear simultaneously in a plurality of squares, possible reward types may be previewed through different colors, guiding the player's strategy.

Considering the difficulty in obtaining the prop, a related obstacle or trap may also be added to a random board square to prevent the player from operating a virtual object to obtain a reward prop.

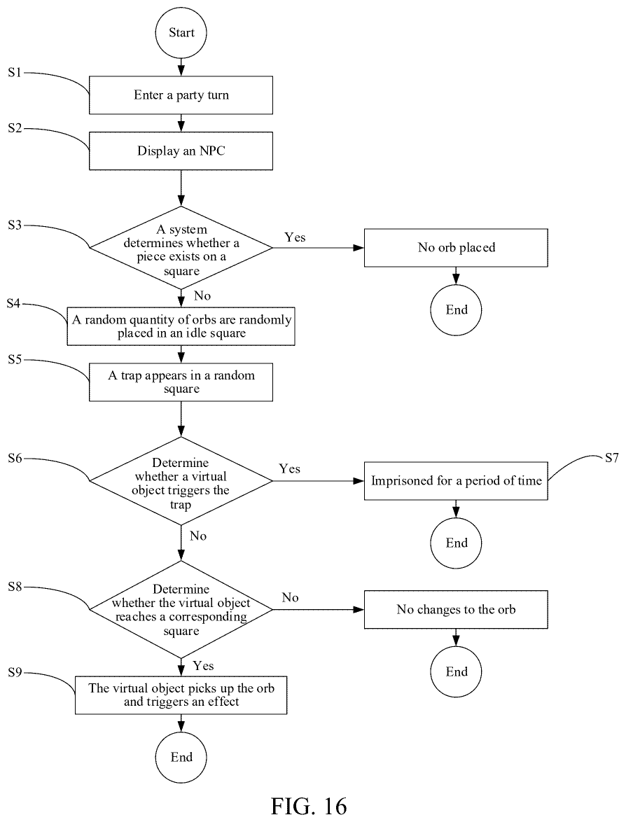

FIG. 16 is a flowchart of a related turn according to some embodiments. The terminal device performs the following back-end operations.

S1: A client determines whether a turn is currently entered.

The turn is a party turn.

S2: Display an NPC on an interface if the turn is entered.

If the special turn is not entered, the turn proceeds as a normal combat round with no special interaction.

S3: A system determines whether a piece exists on a square after a battle turn is entered, for example, whether an idle square exists.

S4: Control the NPC to randomly place a random quantity of reward orbs of random types onto the idle square(s) if one or more idle squares exist.

operations may include.

The client identifies an idle position existing on a current site and feeds back the idle position to the server.

The server randomly configures a random quantity of reward orbs of random types. Reward categories are not limited to a gold coin, a piece, a quantity of refreshes, a turn buff, or a turn debuff to the other party, such as an overall healing effect or an enemy-debuff effect such as reducing an attack speed of the other party.

The server feeds back data to the client after the configuration is complete, and the client randomly places these reward orbs onto the idle square positions.

If no idle square exists, no orb is placed.

S5: A trap appears in a random square.

operations may include.

The server side simultaneously adds a trap setting to another idle square.

A time at which the traps appear may be inconsistent with the time at which the reward orb appears to increase randomness. For example, no trap exists at a square's original position. When the player is about to arrive, the trap is suddenly triggered.

S6: Determine whether a virtual object triggers a trap, for example, determine whether the player moves a virtual object into a trap square.

S7: If a trigger operation of the trap is received, for example, the player moves the virtual object to the trap square to trigger the trap, the virtual object can move only after being stunned or imprisoned for a period of time.

If the player does not enter the trap area, a corresponding effect is not triggered.

S8: Determine whether the virtual object reaches a corresponding orb square, for example, determine whether the virtual object picks up an orb.

S9: Obtain a corresponding reward effect if the virtual object picks up the orb.

Using an example in which the reward effect is the “quantity of refreshes,” the client feeds back the information “the player obtains a refresh reward” to the server. The server releases the free refreshes to the client's store. The player may perform refreshing in the store for the corresponding quantity free of charge.

If the player does not pick up an orb, a corresponding effect is not triggered.

Based on the above, some embodiments provide an interaction mode applied to the auto chess game, which reduces the tedium a player may feel from only being able to wait for a battle result during a combat turn. It adds a specific gameplay element where rewards can be obtained interactively, transforming a standard battle turn into a special round, thereby enriching the player's game experience. A random reward may cause a battle result to be more uncertain, a strong turn-specific buff reward may cause the player to win instead of lose in a current battle, and an economic reward may also give the player more fault tolerance opportunities.

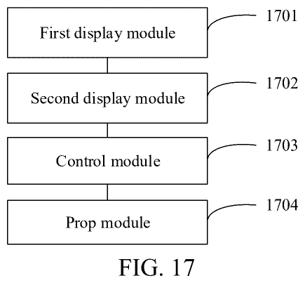

FIG. 17 is a structural block diagram of an apparatus for controlling a virtual object according to some embodiments. The apparatus for controlling includes: a first display module 1701, configured to display a virtual scene, the virtual scene including at least one first virtual object and at least one virtual piece, wherein each of the at least one first virtual object corresponds to one or more virtual pieces; a second display module 1702, configured to place at least one virtual prop into the virtual scene when the virtual piece is in a battle stage; a control module 1703, configured to control, in response to a movement operation for the first virtual object, the first virtual object to move in the virtual scene; and a prop module 1704, configured to trigger a prop effect corresponding to the virtual prop in response to the first virtual object moving to a position corresponding to the virtual prop.

In some embodiments, the virtual scene further includes a second virtual object, and the second virtual object is different from the first virtual object. The at least one virtual prop is placed into the virtual scene by the second virtual object after receiving an instruction to place the at least one virtual prop.

In some embodiments, the virtual scene further includes a virtual board, the virtual board being divided into a plurality of virtual squares, and the virtual piece being located in a corresponding one of the virtual squares.

The second display module 1702 is configured to place a virtual prop on at least one idle virtual square in the virtual board when the virtual piece is in the battle stage.

In some embodiments, the second display module 1702 is configured to display a first marking element on the at least one idle virtual square when the virtual piece is in the battle stage, the first marking element being configured for indicating that a corresponding idle virtual square is designated for placement of the virtual prop; and to place a virtual prop on the at least one idle virtual square after the display of the first marking element has ended.

In some embodiments, the first marking element is further configured for indicating that the corresponding idle virtual square is configured for a prop effect of the placed virtual prop.

In some embodiments, the prop effect includes at least one of the following effects: releasing a virtual resource, restoring an attribute value of the virtual piece, increasing the virtual piece, releasing a virtual item, refreshing a quantity of times the virtual piece is purchasable, refreshing a skill cool-down duration of the virtual piece, and applying a buff effect to the virtual piece.

In some embodiments, the prop effect is applying a buff effect to the virtual piece.

In some embodiments, the prop module 1704 is configured to respectively apply the buff effect to virtual pieces in a first area in the virtual scene, the first area including at least one of the following: an area centered on the first virtual object, a preset area, and an area selected by a user.

In some embodiments, the prop module 1704 is configured to trigger a prop effect corresponding to a first virtual prop when the first virtual object moves to a first virtual square where the first virtual prop is located, the first virtual prop being one of the at least one virtual prop; or to trigger, in response to a trigger operation for a second virtual prop, a prop effect corresponding to the second virtual prop when the first virtual object moves to a second virtual square, the second virtual square being adjacent to a virtual square where the second virtual prop is located, the second virtual prop being another of the at least one virtual prop different from the first virtual prop.

In some embodiments, the apparatus of FIG. 17 further includes a trap module (not shown in the figure), which is configured to apply a trap effect corresponding to the virtual trap to the first virtual object when the first virtual object moves to the virtual square where the virtual trap is located.

In some embodiments, the trap module is configured to display one virtual trap in the at least one idle virtual square in the virtual board, the virtual square where the virtual trap is located being different from a virtual square where the virtual prop is located.

In some embodiments, the trap module is configured to display a second marking element in the at least one idle virtual square, the second marking element being configured for indicating that a corresponding virtual square is designated for the display of the virtual trap; and to display one virtual trap in the at least one idle virtual square after the display of the second marking element has ended.

In some embodiments, the second marking element is further configured to indicate a trap effect of a virtual trap that the corresponding virtual square is designated to display.

In some embodiments, the trap effect includes at least one of the following effects: prohibiting the first virtual object from moving in the virtual scene, reducing a movement speed of the first virtual object, and reducing a hit point of the first virtual object.

In some embodiments, the virtual square where the virtual trap is located is adjacent to the virtual square where the virtual prop is located; or the virtual square where the virtual trap is located is located on a predetermined path, the predetermined path being a shortest path between a position of the first virtual object and the virtual square where the virtual prop is located.

In some embodiments, the apparatus of FIG. 17 further includes a hiding module (not shown in the figure), which is configured to hide the virtual trap when a display duration of the virtual trap reaches a specified duration and the virtual trap is not triggered.

In some embodiments, the battle stage includes one or more battle turns.

The second display module 1702 is configured to perform, in response to the start of a specified one of the one or more battle turns, the operation of placing at least one virtual prop into the virtual scene.

When the apparatus provided in some embodiments implements functions of the apparatus, division of the foregoing various functional modules is used as an example for description. In an actual application, the functional distribution may be completed by different functional modules according to actual requirements; for example, a device architecture may be divided into different functional modules to complete all or some of the functions described above.

manners of performing operations by the modules of the apparatus in some embodiments have been described in detail in some embodiments related to the method. Technical effects obtained by performing the operations by the modules are the same as the technical effects in some embodiments related to the method.

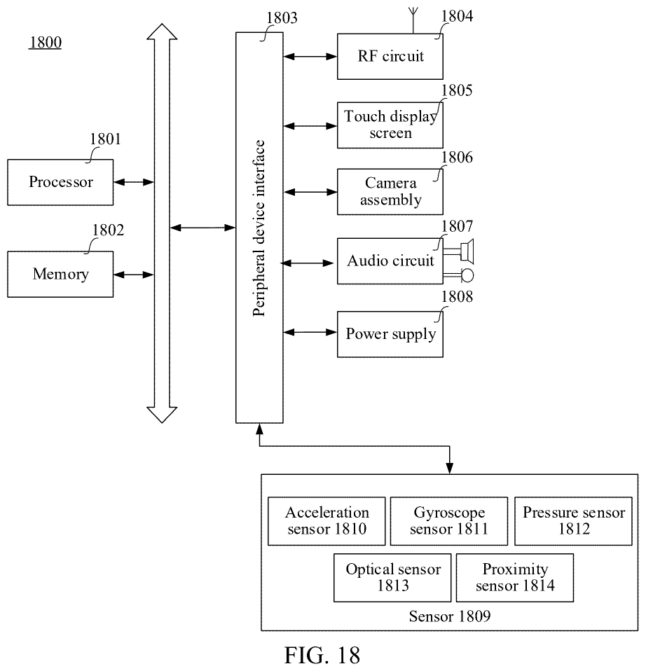

FIG. 18 is a structural block diagram of a computer device according to some embodiments.

The computer device 1800 may be a portable mobile terminal device, for example, a smartphone, a tablet computer, an MP3 player, or an MP4 player. The computer device 1800 may further be referred to as user equipment or a portable terminal device.

The computer device 1800 includes a processor 1801 and a memory 1802.

The processor 1801 may include one or more processing cores, for example, a 4-core processor or an 8-core processor. The processor 1801 may be implemented by using at least one of the following hardware forms: a digital signal processor (DSP), a field-programmable gate array (FPGA), or a programmable logic array (PLA). The processor 1801 may include a main processor and a coprocessor. The main processor is a processor configured to process data in an awake state and is also referred to as a central processing unit (CPU). The coprocessor is a low-power-consumption processor configured to process data in a standby state. In some embodiments, the processor 1801 may be integrated with a graphics processing unit (GPU). The GPU is configured to render and draw content that may be displayed on a display screen. In some embodiments, the processor 1801 may further include an AI processor. The AI processor is configured to process computing operations related to machine learning.

The memory 1802 may include one or more computer-readable storage media. The computer-readable storage medium may be tangible and non-transient. The memory 1802 may further include a high-speed random access memory and a non-volatile memory, for example, one or more disk storage devices and flash storage devices. In some embodiments, a non-transitory computer-readable storage medium in the memory 1802 is configured to store at least one instruction, the at least one instruction being configured to be executed by the processor 1801 to implement the method for controlling a virtual object provided in some embodiments.

In some embodiments, the computer device 1800 may further include a peripheral device interface 1803 and at least one peripheral device. The peripheral device includes at least one of a radio frequency (RF) circuit 1804, a touch display screen 1805, a camera 1806, an audio circuit 1807, and a power supply 1808.

The peripheral device interface 1803 may be configured to connect the at least one peripheral device related to input/output (I/O) to the processor 1801 and the memory 1802. In some embodiments, the processor 1801, the memory 1802, and the peripheral device interface 1803 are integrated on the same chip or the same circuit board. In some embodiments, any one or two of the processor 1801, the memory 1802, and the peripheral device interface 1803 may be implemented on a separate chip or a separate circuit board, which is not limited in some embodiments.

The RF circuit 1804 is configured to receive and transmit an RF signal, which is also referred to as an electromagnetic signal. The RF circuit 1804 communicates with a communication network and another communication device through the electromagnetic signal. The RF circuit 1804 converts an electrical signal into an electromagnetic signal for transmission, or converts a received electromagnetic signal into an electrical signal. In some embodiments, the RF circuit 1804 includes an antenna system, an RF transceiver, one or more amplifiers, a tuner, an oscillator, a digital signal processor, a codec chipset, a user identity module card, and the like. The RF circuit 1804 may communicate with another terminal device through at least one wireless communication protocol. The wireless communication protocol includes, but is not limited to, the World Wide Web, a metropolitan area network, the Intranet, various generations of mobile communication networks (2G, 3G, 4G, and 5G), a wireless local area network, and/or a wireless fidelity (Wi-Fi) network. In some embodiments, the RF 1804 may further include a circuit related to near field communication (NFC), which is not limited in some embodiments.

The touch display screen 1805 is configured to display a UI. The UI may include a graph, text, an icon, a video, or any combination thereof. The touch display screen 1805 further has the capability of acquiring a touch signal on or above its surface. The touch signal may be input into the processor 1801 as a control signal for processing. The touch display screen 1805 is configured to provide a virtual button and/or a virtual keyboard, which are also referred to as soft buttons and/or a soft keyboard. In some embodiments, one touch display screen 1805 may be provided on a front panel of the computer device 1800. In some embodiments, at least two touch display screens 1805 may be provided, which are respectively arranged on different surfaces of the computer device 1800 or in a folded design. In some embodiments, the touch display screen 1805 may be a flexible display screen, which is arranged on a curved surface or a folded surface of the computer device 1800. The touch display screen 1805 may further be arranged in a non-rectangular irregular pattern, for example, a special-shaped screen. The touch display screen 1805 may be manufactured by using a material such as a liquid crystal display (LCD), an organic light-emitting diode (OLED), or the like.

The camera assembly 1806 is configured to capture an image or a video. In some embodiments, the camera assembly 1806 includes a front camera and a rear camera. The front camera is configured to enable video calls or selfies, and the rear camera is configured to take photos or videos. In some embodiments, at least two rear cameras are arranged, which are respectively any of a main camera, a depth-of-field camera, a wide-angle camera, and a telephoto camera, to achieve background blur through fusion of the main camera and the depth-of-field camera, and panoramic photographing and virtual reality (VR) photographing through fusion of the main camera and the wide-angle camera. In some embodiments, the camera assembly 1806 may further include a flash. The flash may be a single-color-temperature flash or a dual-color-temperature flash. The dual-color-temperature flash is a combination of a warm flash and a cold flash, which may be configured for light compensation at different color temperatures.

The audio circuit 1807 is configured to provide an audio interface between the user and the computer device 1800. The audio circuit 1807 may include a microphone and a speaker. The microphone is configured to collect a sound wave of a user and the surrounding environment, and convert the sound wave into an electrical signal and input the electrical signal to the processor 1801 for processing, or input the electrical signal to the RF circuit 1804 to achieve voice communication. For stereo collection or noise reduction, a plurality of microphones may be arranged at different parts of the computer device 1800. The microphone may be an array microphone or an omnidirectional microphone. The speaker is configured to convert an electrical signal from the processor 1801 or the RF circuit 1804 into a sound wave. The speaker may be a film speaker or a piezoelectric ceramic speaker. When the speaker is the piezoelectric ceramic speaker, the speaker may not only convert an electric signal into a sound wave audible to humans, but also convert the electric signal into a sound wave inaudible to humans for purposes such as ranging. In some embodiments, the audio circuit 1807 may further include an earphone jack.

The power supply 1808 is configured to supply power to assemblies in the computer device 1800. The power supply 1808 may be an alternating current battery, a direct current battery, a disposable battery, or a rechargeable battery. When the power supply 1808 includes the rechargeable battery, the rechargeable battery may be a wired rechargeable battery or a wireless rechargeable battery. The wired rechargeable battery is a battery configured to be charged through a wired circuit, and the wirelessly rechargeable battery is a battery configured to be charged through a wireless coil. The rechargeable battery may be further configured to support a fast charging technology.

In some embodiments, the computer device 1800 further includes one or more sensors 1809. The one or more sensors 1809 include but are not limited to an acceleration sensor 1810, a gyroscope sensor 1811, a pressure sensor 1812, an optical sensor 1813, and a proximity sensor 1814.

The acceleration sensor 1810 may detect a magnitude of acceleration on three coordinate axes of a coordinate system established with the computer device 1800. For example, the acceleration sensor 1810 is configured to detect components of gravity acceleration on the three coordinate axes. The processor 1801 may control the touch display screen 1805 to display a UI in a landscape view or a portrait view based on a gravity acceleration signal collected by the acceleration sensor 1810. The acceleration sensor 1810 may be further configured to collect movement data of a game or a user.

The gyroscope sensor 1811 may detect a body direction and a rotation angle of the computer device 1800. The gyroscope sensor 1811 may cooperate with the acceleration sensor 1810 to collect a 3D action performed by a user on the computer device 1800. The processor 1801 may implement the following functions based on the data collected by the gyroscope sensor 1811: motion sensing (for example, change of the UI based on a tilt operation of the user), image stabilization during photographing, game control, and inertial navigation.

The pressure sensor 1812 may be arranged at a side frame of the computer device 1800 and/or a lower layer of the touch display screen 1805. When the pressure sensor 1812 is arranged on the side frame of the computer device 1800, a holding signal of the user on the computer device 1800 may be detected, and left and right hand recognition or a quick operation may be performed based on the holding signal. When the pressure sensor 1812 is arranged on a lower layer of the touch display screen 1805, an operable control on the UI may be controlled based on a pressure operation performed by the user on the touch display screen 1805. The operable control includes at least one of a button control, a scroll-bar control, an icon control, and a menu control.

The optical sensor 1813 is configured to collect ambient light intensity. In some embodiments, the processor 1801 may control display brightness of the touch display screen 1805 based on the ambient light intensity collected by the optical sensor 1813. When the ambient light intensity is relatively high, the display brightness of the touch display screen 1805 is increased; and when the ambient light intensity is relatively low, the display brightness of the touch display screen 1805 is reduced. In some embodiments, the processor 1801 may further dynamically adjust a camera parameter of the camera assembly 1806 based on the ambient light intensity collected by the optical sensor 1813.

The proximity sensor 1814, also referred to as a distance sensor, may be arranged on a front surface of the computer device 1800. The proximity sensor 1814 is configured to collect a distance between the user and a front surface of the computer device 1800. In some embodiments, when the proximity sensor 1814 detects that the distance between the user and the front surface of the computer device 1800 is gradually smaller, the processor 1801 controls the touch display screen 1805 to be switched from a screen-on state to a screen-off state. When the proximity sensor 1814 detects that the distance between the user and the front surface of the computer device 1800 is gradually larger, the processor 1801 controls the touch display screen 1805 to be switched from the screen-off state to the screen-on state.

A person skilled in the art may understand that the structure shown in FIG. 18 does not constitute a limitation on the computer device 1800, and the computer device may include more or fewer assemblies than those shown in the figure, a combination of some assemblies, or different assembly arrangements.

In some embodiments, further provided is a chip including a programmable logic circuit and/or a program instruction, wherein the chip, when run on a computer device, is configured to implement the method for controlling a virtual object provided in some embodiments.

Some embodiments provide a computer-readable storage medium, the computer-readable storage medium having a computer program stored therein, the computer program being loaded and executed by a processor to implement the method for controlling a virtual object provided in some embodiments.

Some embodiments further provide a computer program product or a computer program. The computer program product or the computer program includes a computer program stored in a computer-readable storage medium. A processor of a computer device reads the computer program from the computer-readable storage medium, and the program is loaded and executed by the processor to implement the method for controlling a virtual object provided in some embodiments.

The sequence numbers of some embodiments are for descriptive purposes only and do not indicate a preference among the embodiments.

A person of ordinary skill in the art may understand that all or some of the operations of some embodiments may be implemented by hardware, or may be implemented by a program instructing relevant hardware. The program may be stored in a computer-readable storage medium. The foregoing computer-readable storage medium may be a read-only memory, a magnetic disk, an optical disc, or the like.

A person skilled in the art should understand that in the foregoing examples, the functions described in some embodiments may be implemented by hardware, software, firmware, or any combination thereof. When implemented by software, the functions may be stored in a computer-readable medium or may be used as one or more instructions or codes in a computer-readable medium for transmission. The computer-readable medium includes a computer storage medium and a communication medium. The communication medium includes any medium that enables a computer program to be transmitted from one place to another. The storage medium may be any available medium accessible to a general-purpose or dedicated computer.

The foregoing embodiments are provided for description rather than limitation of the technical solutions of the disclosure. A person of ordinary skill in the art shall understand that although the disclosure has been described in detail with reference to the foregoing embodiments, modifications may be made to the technical solutions described in the foregoing embodiments, or equivalent replacements may be made to some technical features in the technical solutions, provided that such modifications or replacements do not cause the essence of the corresponding technical solutions to depart from the spirit and scope of the embodiments of the disclosure and the appended claims.

What is claimed is:

1. A method for controlling a virtual object, performed by a computer device, the method comprising:
displaying a virtual scene comprising a first virtual object and a first virtual piece, wherein the first virtual object corresponds to one or more virtual pieces including the first virtual piece;
placing a virtual prop in the virtual scene when the first virtual piece is in a battle stage;
controlling, based on a movement operation for the first virtual object, the first virtual object to move in the virtual scene; and
triggering, based on the first virtual object moving to a position corresponding to the virtual prop, a prop effect of the virtual prop.

2. The method according to claim 1, wherein the virtual scene further comprises a second virtual object different from the first virtual object, and
wherein the placing the virtual prop comprises causing, based on an instruction to place the virtual prop, the second virtual object to place the virtual prop in the virtual scene.

3. The method according to claim 1, wherein the virtual scene further comprises a virtual board comprising a plurality of virtual squares,
wherein the first virtual piece is located in a first virtual square of the plurality of virtual squares, and
wherein the placing the virtual prop comprises placing the virtual prop on a first idle virtual square of the plurality of virtual squares.

4. The method according to claim 3, wherein the placing the virtual prop on the first idle virtual square is preceded by displaying a first marking element on the first idle virtual square indicating that the first idle virtual square is designated for placement of the virtual prop.

5. The method according to claim 4, wherein the first marking element further indicates the prop effect of the virtual prop.

6. The method according to claim 1, wherein the prop effect comprises at least one of: releasing a virtual resource, restoring an attribute value of the first virtual piece, adding a second virtual piece, releasing a virtual item, refreshing a number of times the first virtual piece is purchasable, refreshing a skill cool-down duration of the first virtual piece, or applying a buff effect to the first virtual piece.

7. The method according to of claim 1, wherein the prop effect comprises applying a buff effect to virtual pieces within a first area of the virtual scene, the first area being at least one of: an area centered on the first virtual object, a preset area, or a user-selected area.

8. The method according to of claim 3, wherein the triggering the prop effect comprises:
triggering the prop effect based on the first virtual object moving to the first idle virtual square where the virtual prop is located; or
triggering the prop effect, based on a trigger operation for the virtual prop, when the first virtual object moves to a second virtual square adjacent to the first idle virtual square where the virtual prop is located.

9. The method according to of claim 3, wherein the virtual scene further comprises a virtual trap located in a virtual square of the plurality of virtual squares, and
wherein the method further comprises applying a trap effect corresponding to the virtual trap to the first virtual object based on the first virtual object moving to the virtual square where the virtual trap is located.

10. The method according to claim 9, further comprising displaying the virtual trap in a second idle virtual square of the plurality of virtual squares, wherein the second idle virtual square is different from the first idle virtual square.

11. An apparatus for controlling a virtual object, the apparatus comprising:
at least one memory configured to store computer program code; and
at least one processor configured to read the program code and operate as instructed by the program code, the program code comprising:
first display code configured to cause at least one of the at least one processor to display a virtual scene comprising a first virtual object and a first virtual piece, wherein the first virtual object corresponds to one or more virtual pieces including the first virtual piece;
second display code configured to cause at least one of the at least one processor to place a virtual prop in the virtual scene when the first virtual piece is in a battle stage;
control code configured to cause at least one of the at least one processor to control, based on a movement operation for the first virtual object, the first virtual object to move in the virtual scene; and
prop code configured to cause at least one of the at least one processor to trigger, based on the first virtual object moving to a position corresponding to the virtual prop, a prop effect of the virtual prop.

12. The apparatus of claim 11, wherein the virtual scene further comprises a second virtual object different from the first virtual object, and
wherein the second display code is configured to cause at least one of the at least one processor to place the virtual prop by causing, based on an instruction to place the virtual prop, the second virtual object to place the virtual prop in the virtual scene.

13. The apparatus of claim 11, wherein the virtual scene further comprises a virtual board comprising a plurality of virtual squares,
wherein the first virtual piece is located in a first virtual square of the plurality of virtual squares, and
wherein the second display code is configured to cause at least one of the at least one processor to place the virtual prop on a first idle virtual square of the plurality of virtual squares.

14. The apparatus of claim 13, wherein the second display code is configured to cause at least one of the at least one processor to display a first marking element on the first idle virtual square prior to placing the virtual prop, the first marking element indicating that the first idle virtual square is designated for placement of the virtual prop.

15. The apparatus of claim 14, wherein the first marking element further indicates the prop effect of the virtual prop.

16. The apparatus of claim 11, wherein the prop code is configured to cause at least one of the at least one processor to trigger a prop effect comprising at least one of: releasing a virtual resource, restoring an attribute value of the first virtual piece, adding a second virtual piece, releasing a virtual item, refreshing a number of times the first virtual piece is purchasable, refreshing a skill cool-down duration of the first virtual piece, or applying a buff effect to the first virtual piece.

17. The apparatus of claim 11, wherein the prop code is configured to cause at least one of the at least one processor to trigger the prop effect by applying a buff effect to virtual pieces within a first area of the virtual scene, the first area being at least one of: an area centered on the first virtual object, a preset area, or a user-selected area.

18. The apparatus of claim 13, wherein the prop code is configured to cause at least one of the at least one processor to:
trigger the prop effect based on the first virtual object moving to the first idle virtual square where the virtual prop is located; or
trigger the prop effect, based on a trigger operation for the virtual prop, when the first virtual object moves to a second virtual square adjacent to the first idle virtual square where the virtual prop is located.

19. The apparatus of claim 13, wherein the virtual scene further comprises a virtual trap located in a virtual square of the plurality of virtual squares, and
wherein the program code further comprises trap code configured to cause at least one of the at least one processor to apply a trap effect corresponding to the virtual trap to the first virtual object based on the first virtual object moving to the virtual square where the virtual trap is located.

20. A non-transitory computer-readable storage medium, storing computer code which, when executed by at least one processor, causes the at least one processor to:
display a virtual scene comprising a first virtual object and a first virtual piece, wherein the first virtual object corresponds to one or more virtual pieces including the first virtual piece;
place a virtual prop in the virtual scene when the first virtual piece is in a battle stage;
control, based on a movement operation for the first virtual object, the first virtual object to move in the virtual scene; and
trigger, based on the first virtual object moving to a position corresponding to the virtual prop, a prop effect of the virtual prop.
